(19) United States
(12) Patent Application Publication
(10) Pub. No.: US 2008/0090692 A1
(43) Pub. Date: Apr. 17, 2008

(54) Transfer case center differential

(76) Inventor: Luther H. Gates, Coatesville, PA (US)

Correspondence Address: HARNESS, DICKEY & PIERCE, P.L.C., P.O. BOX 828, BLOOMFIELD HILLS, MI, 48303, US

(21) Appl. No.: 11/582,945

(22) Filed: Oct. 17, 2006

(51) Int. Cl. F16H 48/06

(52) U.S. Cl. 475/249

(57) ABSTRACT

A torque transfer assembly for use in a motor vehicle having a power source, a first set of wheels and a second set of wheels. The torque transfer assembly includes a first shaft adapted to be driven by the power source, a second shaft adapted to transmit torque to the first set of wheels, a third shaft adapted to transmit torque to the second set of wheels and a differential receiving torque from the first shaft and continuously transferring torque to the second shaft. The differential includes a housing, a plurality of compound pinion gears, a first sun gear and a second sun gear. The housing includes a first member of a final drive assembly integrally formed therewith.

### BACKGROUND

The present disclosure relates generally to power transfer assemblies for use in motor vehicles. More particularly, the present disclosure relates to a center differential assembly within a torque path of a power transfer assembly.

Currently, many four-wheel and all-wheel drive vehicles utilize a transfer case in receipt of torque behind the transmission to allow the engine's power to be sent to both the front and rear wheels. To provide desirable vehicle handling characteristics, transfer cases that are to be used full-time under a number of varying road conditions may need to allow for a difference in speed between the front and rear tires. Typically, this need is satisfied by positioning a differential within the torque path between front and rear axles. Some designs require relatively large volumes of packaging space while also adding undesirable weight.

Other designs include transfer cases having a geared differential. Differentials presently used in production transfer cases may include a housing, a front output gear, a rear output gear and various pinion side gears that connect the outputs to the housing. Often, the engine torque is delivered into the housing and then through the pinions to the front and rear output gears. A presently known differential includes two rows of pinions to ensure that the front and rear outputs rotate in the appropriate directions.

While such strategies may generally work in a satisfactory manner, a need for an improved power transfer arrangement exists. In particular, a need exists for a torque transfer assembly operable to provide speed differentiation between the front and rear wheels of the vehicle at a reduced cost and weight.

### SUMMARY OF THE INVENTION

The present disclosure includes a torque transfer assembly for use in a motor vehicle having a power source, a first set of wheels and a second set of wheels. The torque transfer assembly includes a first shaft adapted to be driven by the power source, a second shaft adapted to transmit torque to the first set of wheels, a third shaft adapted to transmit torque to the second set of wheels and a differential receiving torque from the first shaft and continuously transferring torque to the second shaft. The differential includes a housing, a plurality of compound pinion gears, a first sun gear and a second sun gear. The housing includes a first member of a final drive assembly integrally formed therewith.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The disclosure will now be described, by way of example, with reference to the accompanying drawings in which:

FIG. 1 is a schematic illustrating the drivetrain of a motor vehicle equipped with a transfer case of the present disclosure;

FIG. 2 is a cross-sectional side view of a transfer case of the present disclosure;

FIG. 3 is a cross-sectional side view of a center differential assembly associated with the transfer case shown in FIG. 2;

FIG. 4 is a front view of the center differential assembly associated with the transfer case shown in FIG. 2;

FIG. 5 is an exploded perspective view of an alternate transfer case of the present disclosure; and

FIG. 6 is a cross-sectional side view of the transfer case shown in FIG. 5.

### DETAILED DESCRIPTION OF THE PREFERRED EMBODIMENTS

The present disclosure is directed to a center differential assembly or front-to-rear torque balancing assembly for use in a motor vehicle equipped with an engine and transmission and which may be arranged to provide a full or part-time four-wheel drive mode of operation.

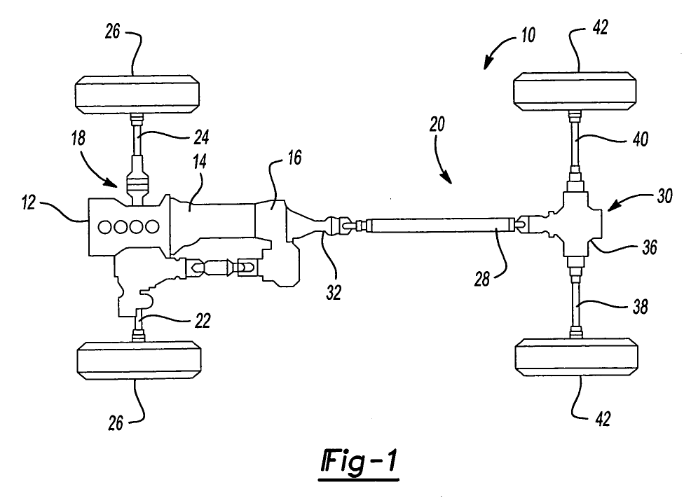

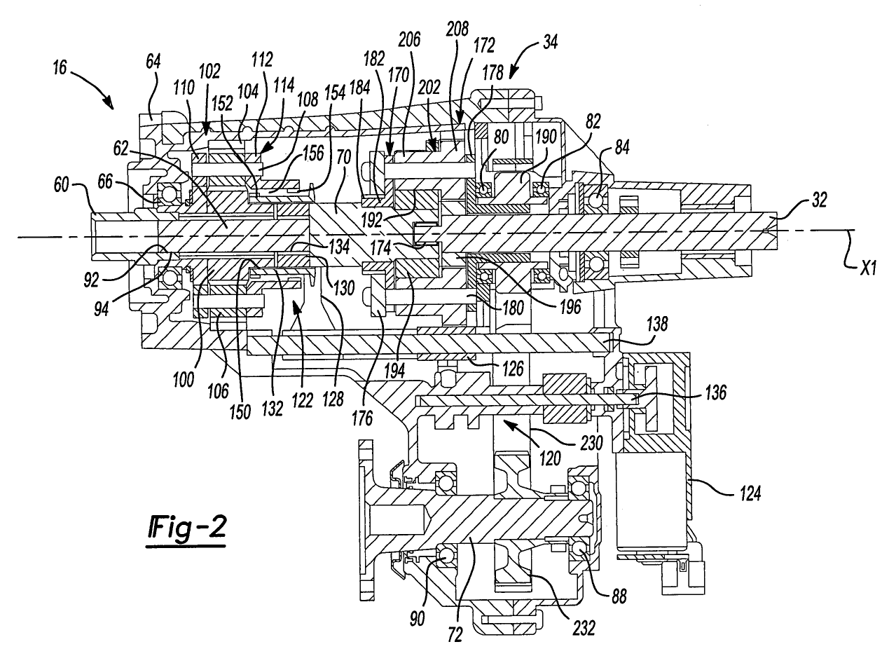

With particular reference to FIG. 1, a schematic of a motor vehicle 10 is shown to include a longitudinally mounted engine 12 and a transmission 14 adapted to deliver motive power (i.e., drive torque) to the input of a transfer case 16. Transfer case 16 is shown as a full-time all-wheel drive system and is operable to transfer drive torque to a front driveline 18 and a rear driveline 20. However, transfer case 16 may be adapted for use in a part-time four-wheel drive system as well. Front driveline 18 includes a first output or left half-shaft 22 and a second output or right half-shaft 24. Half-shafts 22 and 24 are connected to a first pair of ground-engaging wheels 26. Rear driveline 20 includes a driveshaft 28 and a rear axle assembly 30. One end of driveshaft 28 is connected to a rear output or second shaft 32 of a center differential assembly 34 (FIG. 2) within transfer case 16. The opposite end of driveshaft 28 is connected to a rear differential 36 associated with rear axle assembly 30. Rear axle assembly 30 further includes a pair of axleshafts 38 and 40 which connect a second pair of ground-engaging wheels 42 to rear differential 36.

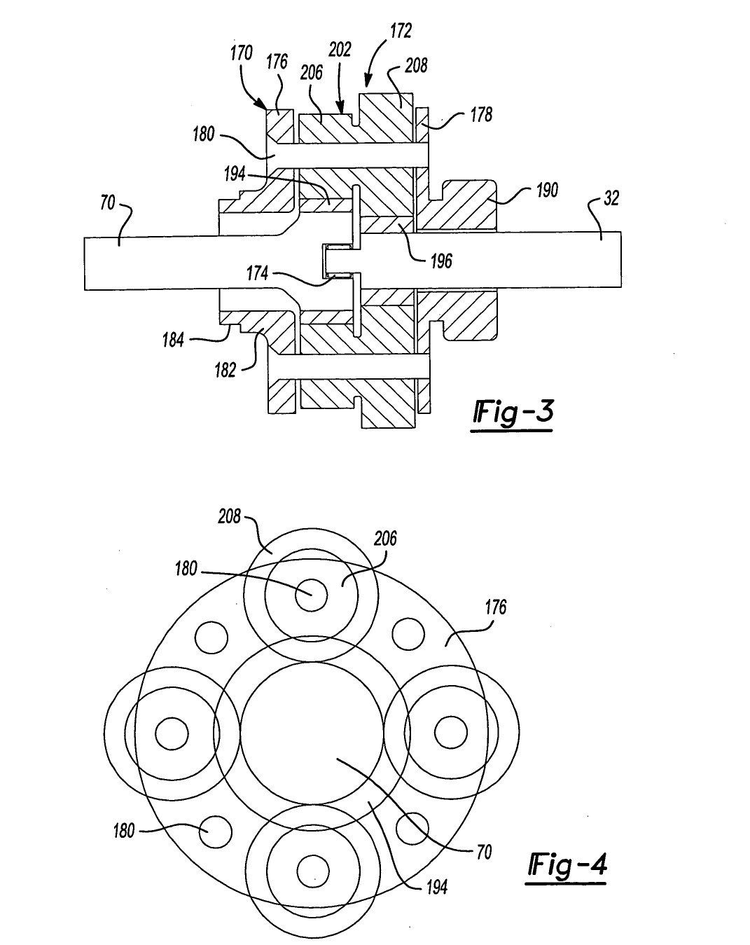

FIGS. 2-4 depict transfer case 16 including a transmission coupling shaft 60 fixed for rotation with a transfer case input shaft 62. Transmission coupling shaft 60 and transfer case input shaft 62 are rotatably supported in a transfer case housing 64 by a first bearing 66. Center differential assembly 34 transfers drive torque to rear output shaft 32 and a front output or third shaft 72. Rear output shaft 32 is rotatably supported in transfer case housing 64 by second, third and fourth bearings 80, 82 and 84 and front output shaft 72 is rotatably supported on transfer case housing 64 by a sixth and seventh bearing 88 and 90.

Internal splines 92 of transmission coupling shaft 60 are drivingly engaged with external splines 94 of transfer case input shaft 62. Transfer case input shaft 62 is splined to a sun gear 100 of a low-range planetary gearset 102. Low-range planetary gearset 102 also includes a ring gear 104 fixed to transfer case housing 64. Each pinion gear 106 of a set of pinion gears is rotatably supported on a pinion shaft 108 and meshed with sun gear 100 and ring gear 104. Each pinion shaft 108 extends between a front carrier ring 110 and a rear carrier ring 112 which are interconnected to define a carrier assembly 114.

Low-range planetary gearset 102 along with a shifting mechanism 120 comprise a range shifting assembly 122. Shifting mechanism 120 includes an actuator 124, a shift collar 126, a shift fork 128, a shift hub 130 and a sleeve 132. Sleeve 132 is in continuous driving engagement with input shaft 70. Shift hub 130 is rotatably supported on transfer case input shaft 62 by an eighth bearing 134 and externally splined to engage sleeve 132. Shifting mechanism 120 is operable to axially translate sleeve 132 along shift hub 130 and selectively couple input shaft 70 to either of carrier assembly 114 or sun gear 100 through sleeve 132. Shifting mechanism 120 may be structured as a manually operated device or may include a powered actuator, such as actuator 124, to perform the range shift.

Actuator 124 rotates a motor drive shaft 136 in either a clockwise or counter-clockwise direction. Motor drive shaft 136 is threadingly engaged with shift collar 126 such that rotation of motor drive shaft 136 causes linear translation of shift collar 126. Shift collar 126 is fixed with shift fork 128. Shift fork 128 is in engagement with sleeve 132. Accordingly, when actuator 124 rotates in a first direction, the rotation of motor drive shaft 136 axially slides shift collar 126 along a guide shaft 138 in a first axial direction. This translation causes shift collar 126 to apply a force on sleeve 132 through shift fork 128. Sleeve 132 is translated in a first direction. When actuator 124 rotates in a second direction, the rotation of motor drive shaft 136 axially slides shift collar 126 along guide shaft 138 in a second and opposite axial direction. This translation causes shift collar 126 to apply an opposite force on sleeve 132 through shift fork 128. Sleeve 132 is translated in a second direction.

Low-range planetary gearset 102 and shifting mechanism 120 function as a two-speed gear reduction unit operable to establish a first or high-range speed ratio drive connection or a second or low-range speed ratio drive connection between transmission coupling shaft 60 and input shaft 70. As shown, the high-range speed ratio drive connection is established between transmission coupling shaft 60 and input shaft 70 by axially translating sleeve 132 to engage internal splines 150 with external splines 152 formed on sun gear 100. The low-range speed ratio drive connection is established by coupling input shaft 70 to rear carrier ring 112 through sleeve 132. In particular, rear carrier ring 112 includes internal teeth 154 selectively engageable with a set of external teeth 156 formed on sleeve 132 such that driven rotation of carrier assembly 114 causes concurrent rotation of sleeve 132. A neutral mode is established when sleeve 132 is uncoupled from both carrier assembly 114 and sun gear 100.

Input shaft 70 partially extends into a carrier 170 of a differential planetary gearset 172 and rotatably supports rear output shaft 32 on a ninth bearing 174. Carrier 170 includes a first or front portion 176 coupled to a second or rear portion 178 by fasteners 180. Front portion 176 includes a tubular portion 182 having external splines 184. Rear portion 178 includes a first or drive sprocket 190 which may be integrally formed therewith.

Sleeve 132 is also axially moveable along input shaft 70 by shifting mechanism 120 to engage tubular portion 182 while maintaining engagement with low-range planetary gearset 102 in the low-speed ratio drive connection. At a first or “open” differential position, sleeve 132 is engaged with carrier assembly 114 and input shaft 70 to operate vehicle 10 at an “open” differential, low-speed range. At a second or “locked” differential position, sleeve 132 is fixed for rotation with carrier assembly 114, input shaft 70 and external splines 184 of tubular portion 182 to operate vehicle 10 in a “locked” differential, low-speed range.

Input shaft 70 is drivingly engaged with first sun gear 194 having a first diameter. Differential planetary gearset 172 further includes a final driven or second sun gear 196 having a second diameter, and a plurality of compound pinion gears 202. The first diameter is greater than the second diameter. Compound pinion gears 202 include first and second portions 206 and 208 rotatably supported by carrier 170 on fasteners 180 functioning as pinion shafts. First portion 206 has a third diameter smaller than a fourth diameter of second portion 208. First sun gear 194 is drivingly engaged with first portions 206 of compound pinion gears 202. Second portions 208 are drivingly engaged with second sun gear 196. Second sun gear 196 is fixed for rotation with rear output shaft 32.

Alternatively, first sun gear 194 may be integrally formed on input shaft 70 to drivingly engage first portion 206. Second sun gear 196 may be integrally formed on rear output shaft 32 to drivingly engage second portion 208 of compound pinion gears 202. A flexible member 230 interconnects drive sprocket 190 to a driven sprocket 232 fixed to front output shaft 72.

There are various advantages in packaging and forming center differential assembly 34 as described above. First, integrally forming drive sprocket 190 with carrier 170 from a single piece of material lowers cost, mass, and inertia of the overall assembly. Secondly, the components are able to be more compactly packaged reducing overall vehicle cost and leaving more space for other vehicle elements. Finally, the current design is easily adaptable to incorporate a limited slip differential by adding elements such as a viscous clutch pack and/or a helical gear set with springs.

Center differential assembly 34 and shifting mechanism 120 function as a torque balancing system between front and rear ground engaging wheels 26 and 42. When sleeve 132 is in the “open” position, first sun gear 194 transfers drive torque to first portions 206 rotating compound pinion gears 202 about axis X, and their respective pinion shaft axes. This rotation causes second portions 208 of compound pinion gears 202 to drive second sun gear 196 transferring drive torque to rear output shaft 32. The rotation of carrier 170 transfers drive torque from drive sprocket 190 to driven sprocket 232 through flexible member 230. Driven sprocket 232 transfers the drive torque to front output shaft 72. Thus, both front and rear output shafts 72 and 32 receive drive torque.

When one set of ground engaging wheels 26, 42 experiences a lower “mu” characteristic than the other, the “open” differential loses the ability to transfer torque to the other set of ground engaging wheels 26, 42. However, when sleeve 132 is translated to the “locked” position, drive torque is transferred to both first portion 206 and carrier 170 directly from input shaft 70. This allows the front and rear ground engaging wheels 26 and 42 to continuously receive drive torque from front and rear output shafts 72 and 32, respectively.

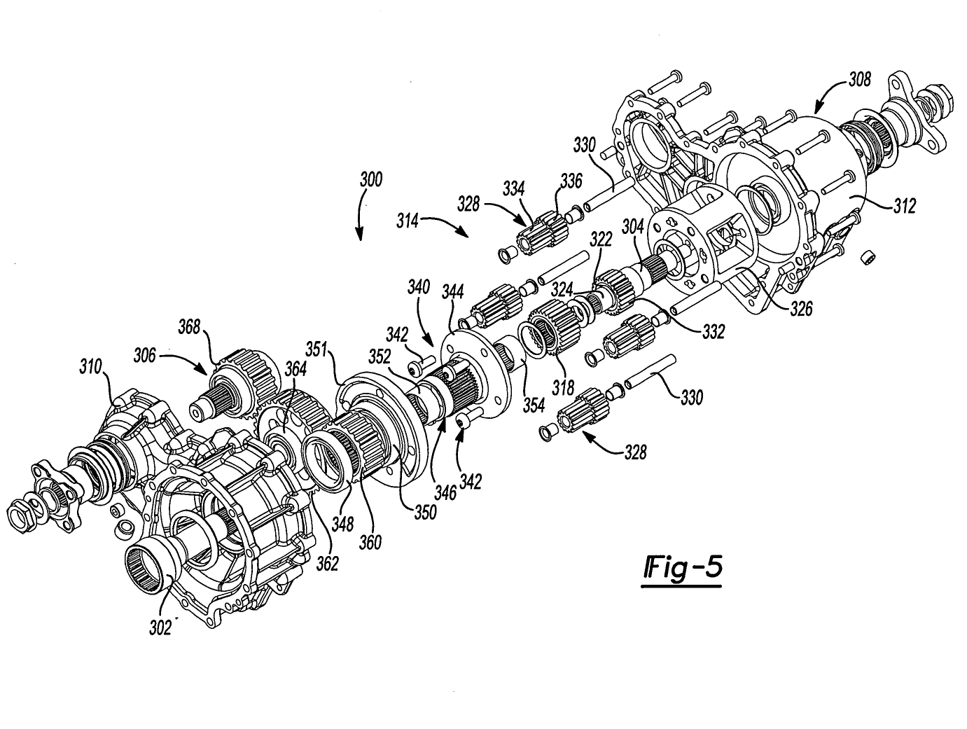

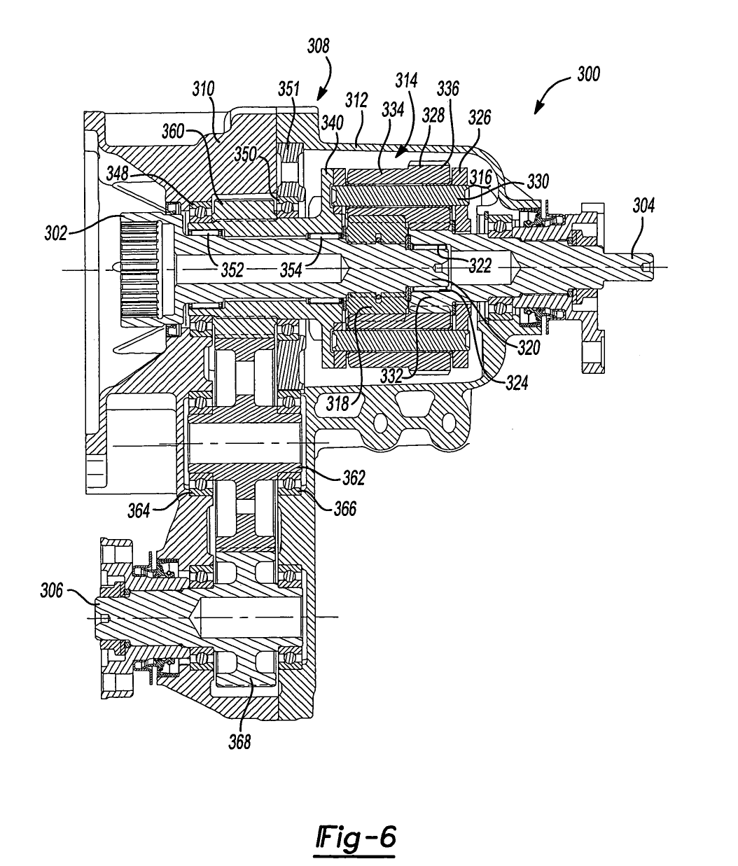

FIGS. 5 and 6 depict a transfer case 300. Transfer case 300 is a single speed, full-time unit continuously transferring torque from an input shaft 302 to a first output shaft 304 and a second output shaft 306. First output shaft 304 provides torque to rear driveline 20 while second output shaft 306 provides drive torque to front driveline 18. A housing assembly 308 includes a front housing half 310 fixed to a rear housing half 312. A center differential assembly 314 is positioned within a cavity 316 defined by second housing half 312. Second housing half 312 also rotatably supports first output shaft 304.

Input shaft 302 is splined in driving engagement with a first sun gear 318 of center differential assembly 314. A portion 320 of input shaft 302 extends within a pocket 322 formed in first output shaft 304. A bearing 324 rotatably supports first output shaft 304 on input shaft 302. Center differential assembly 314 also includes a carrier housing 326, compound pinion gears 328, pinion shafts 330 and a second sun gear 332. Compound pinion gears 328 are rotatably supported on pinion shafts 330. A first smaller diameter portion 334 of compound pinion gears 328 is in meshing engagement with first sun gear 318. A second larger diameter portion 336 of compound gears 328 is in driving engagement with second sun gear 332.

Carrier housing 326 is fixed to a drive hub 340 by a plurality of fasteners 342. Drive hub 340 includes a mounting flange 344 and an externally splined tubular portion 346. Drive hub 340 is rotatably supported by first and second bearings 348 and 350. Bearing 350 is supported by a plate 351 coupled to second housing half 312. Input shaft 302 is rotatably supported within drive hub 340 by bearings 352 and 354. A first driven gear 360 is in splined driving engagement with drive hub 340. Drive gear 360 is in meshed engagement with an intermediate gear 362. Intermediate gear 362 is rotatably supported by bearings 364 and 366 within first housing half 310. An output gear 368 is in meshed engagement with intermediate gear 362. Output gear 368 is integrally formed with second output shaft 306.

Based on the component arrangement and interconnection previously described, transfer case 300 is a compact, low cost and low weight torque transfer assembly operable to provide speed differentiation between first output shaft 304 and drive hub 340. In the embodiment shown, center differential assembly 314 provides a gear reduction ratio of 2:1. Other gear ratios may be provided to allow various front-to-rear torque splits. Drive hub 340 outputs a reduced torque of first output shaft 304. Because drive gear 360 is fixed for rotation with drive hub 340, drive gear 360 rotates in the same direction of first output shaft 304. First output shaft 304 also rotates in the same direction as drive gear 360. Accordingly, the torque transfer mechanisms of the present disclosure provide high functionality while being equipped with fewer components in a relatively small packaging volume.

The foregoing discussion discloses and describes various embodiments of the present disclosure. One skilled in the art will readily recognize from such discussion, and from the accompanying drawings and claims, that various changes, modifications and variations can be made therein without departing from the true spirit and fair scope of the disclosure as defined in the following claims.

What is claimed is:

1. A torque transfer assembly for use in a four-wheel drive vehicle having a power source, a first set of ground engaging wheels and a second set of ground engaging wheels, the torque transfer assembly comprising:
a first shaft adapted to be driven by a power source;
a second shaft adapted to transmit torque to said first set of ground engaging wheels;
a third shaft adapted to transmit torque to said second set of ground engaging wheels; and
a differential unit receiving torque from said first shaft and continuously transferring torque to said second and said third shafts, said differential unit including a housing, a plurality of compound pinion gears, a first sun gear and a second sun gear, said housing including a first member of a final drive assembly integrally formed therewith.

2. The torque transfer assembly of claim 1 wherein said first member of said final drive assembly includes a first sprocket.

3. The torque transfer assembly of claim 2 wherein a second sprocket is drivingly connected to said first sprocket by a flexible member.

4. The torque transfer assembly of claim 3 wherein said second sprocket is integrally formed with said third shaft.

5. The torque transfer assembly of claim 1 wherein said first and second shafts rotate about a common axis, said first member being positioned a lesser distance from a distal end of said second shaft than said differential unit.

6. The torque transfer assembly of claim 1 wherein said first member of said final drive assembly is a gear in meshed engagement with an intermediate gear which is also in meshed engagement with a final gear fixed to said third shaft.

7. The torque transfer assembly of claim 6 wherein said third shaft is integrally formed with said final gear.

8. The torque transfer assembly of claim 1 wherein said first and second shafts rotate about a common axis, said first member being positioned a greater distance from a distal end of said second shaft than said differential unit.

9. The torque transfer assembly of claim 1 wherein said first shaft is rotatably supported by said second shaft.

10. The torque transfer assembly of claim 1 wherein a larger of said first and second sun gears is integrally formed on said first shaft.

11. The torque transfer assembly of claim 1 further including a mechanism selectively operable to fix said first shaft to said housing to operate said differential in a locked mode.

12. The torque transfer assembly of claim 1 wherein said rear output shaft extends through said first member of said final drive assembly.

13. A transfer case for use in a motor vehicle having an engine, a front set of wheels and a rear set of wheels, the transfer case comprising:
a housing;
an input shaft rotatably supported in said housing and adapted to be driven by said engine;
a rear output shaft rotatably supported in said housing and adapted to transmit torque to said rear set of wheels;
a front output shaft rotatably supported in said housing and adapted to transmit torque to said front set of wheels; and
a differential assembly having a case rotatably supported in said housing at only one end of said case, a plurality of compound pinion gears, a first sun gear and a second sun gear, said input shaft driving said first sun gear, said second sun gear driving said rear output shaft and said case driving a first member of an output reduction unit, a last member of the output reduction unit driving said front output shaft.

14. The transfer case of claim 13 wherein said rear output shaft rotatably supports said input shaft within a pocket formed in said rear output shaft.

15. The transfer case of claim 13 further including a hub having a cylindrically-shaped tube section rotatably supported by said housing and a radially extending flange section fixed to said case.

16. The transfer case of claim 15 wherein said tube section is fixed to said first member of said output reduction unit.

17. The transfer case of claim 16 wherein said tube section rotatably supports said input shaft.

18. A transfer case assembly for use in a motor vehicle having an engine and front and rear sets of wheels, the transfer case comprising:
a first shaft adapted to be driven by said engine;
a second shaft adapted to transmit torque to said rear set of wheels;
a third shaft adapted to transmit torque to said front set of wheels;
a differential including a planetary gearset including a housing, four pinion gears and two sun gears, each of said pinion gears including a large diameter gear portion and a small diameter gear portion, one of said sun gears being a large diameter, the other of said sun gears being a smaller diameter, said large sun gear being formed on said first shaft, said smaller sun gear being formed on said second shaft, said housing including an integral first sprocket positioned at a rear end of said differential; and
a flexible member drivingly engaged with said first sprocket, said flexible member transferring torque from said first sprocket to a second sprocket integrally formed on said third shaft.

19. The transfer case assembly of claim 18 wherein said first sprocket and said housing are manufactured as a unitary component from a single piece of material.

20. The transfer case assembly of claim 18 wherein said differential is lockable wherein said front and rear wheels continuously receive drive torque.

21. The transfer case assembly of claim 18 wherein said planetary gearset provides a total gear ratio of 2.0:1.

22. The transfer case assembly of claim 18 further including another planetary gear set forming part of a two-speed range shift mechanism.
